(19) United States
(12) Patent Application Publication
(10) Pub. No.: US 2013/0078405 A1
(43) Pub. Date: Mar. 28, 2013

(54) SELF-ADHESIVE PADS

(71) Applicant: Brian Schryver, Redwood City, CA (US)

(72) Inventor: Brian Schryver, Redwood City, CA (US)

(73) Assignee: BIOCISION, LLC, Mill Valley, CA (US)

(21) Appl. No.: 13/626,274

(22) Filed: Sep. 25, 2012

Related U.S. Application Data
(60) Provisional application No. 61/539,811, filed on Sep. 27, 2011.

(51) Int. Cl. B32B 3/10; B65D 65/28; B32B 33/00; B32B 7/14; B32B 3/02

(52) U.S. Cl. 428/40.1; 428/195.1; 428/192; 428/43

(57) ABSTRACT

A self-adhesive pad for use in a laboratory setting.

### RELATED APPLICATIONS

This application claims priority to U.S. Provisional Patent Application Ser. No. 61/539,811, entitled SELF-ADHESIVE PADS, filed on Sep. 27, 2011, which is incorporated herein by reference in its entirety.

### BACKGROUND

The laboratory environment frequently requires the use and transfer of liquid materials. For example, a laboratory researcher in a single day may work with buffers, culture media, cell lysates, enzyme solution, aqueous reagents, solvents, water baths, and ice/water mixtures, to name only a few of the possible liquids. For both laboratory safety, clean-up convenience, and contamination control, a laboratory worker will often cover the laboratory bench top with a thin absorbent material that has a liquid-barrier backing to prevent spilled liquids from penetrating to the bench surface, thereby facilitating the clean-up process and limiting or preventing contamination of the working surface. Varieties of such materials are commercially available and are commonly known and used by those familiar to the laboratory environment. The material is provided in multiple formats, including bulk roll material that is cut to length as required, and pre-cut individual pad segments. A representative example of the material used in these pads, commonly called surface protectors or absorbent bench underpads, is supplied by VWR International, catalog number 56617-008 and is described on its commercial web site to be “a top sheet that is made of a soft white spunbound polypropylene. The absorbent cellulose fluff filler, sandwiched between two layers of tissue . . . . The backing sheet . . . is made of embossed polypropylene. Each pad is sealed on four sides to prevent liquid seepage”

The waterproof backing that is provided with the absorbent material (the combination of which will hereafter be referred to as a “bench pad”) is often a plastic material that is low in friction, and, combined with the light weight and large surface area of the material, is subject to displacement by mechanical forces or air currents. In addition, laboratory bench pads are used to cover mobile cart surfaces and the lateral forces imposed during transit may cause cart loads resting on bench pads to shift and slide as a result. To counteract the natural mobility of the bench pad, it is a common practice for the bench pad to be affixed to a surface with adhesive tape. Often a tape is selected which does not have sufficient tensile strength, is not waterproof, has too weak or too strong a bonding property, bleeds color when wet or in contact with solvents, or leaves residue when removed. In addition, a source of adhesive tape is not always available when required.

Therefore, there is a need for a bench pad that is pre-configured with adhesive bonding strips or regions with the desirable material and adhesive properties that can be readily deployed at the moment of installation. The devices of this invention meet this need.

### BRIEF SUMMARY OF THE INVENTION

The invention provides a bench pad that is pre-configured with a plurality of adhesive tab extensions or backing adhesive regions that may be deployed at will to affix the bench pad to a working surface. The pad material may be provided in a variety of widths, typically from 12 to 36 inches, and can be supplied in bulk roll or cut to individual lengths, typically from 12 to 36 inches. In some embodiments the invention comprises individual pads with a width of 16 to 18 inches and a length from 20 to 24 inches. The pads may be constructed in layers, where individual layers provide different functions for liquid containment. As an example (not intended to limit the scope of the invention), a pad may be constructed with a non-porous, non-absorbent underside sheet constructed from a hydrophobic material such as polyethylene or polypropylene that acts as a liquid barrier that contains any pooled or absorbed liquids in the pad and prevents the liquid from contacting the supporting surface on which the pad is placed and prevents the liquid from flowing laterally beyond the edges of the pad. Central layers of the pad may be constructed from a highly absorbent material such as cellulose or chemically modified cellulose. A top layer of the pad may comprise a hydrophobic mesh material, such as spun polypropylene, that will both contain the middle absorbent layer and reduce surface tension adherence of the absorbent layers to object resting on the absorbent pads.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. These drawings depict only typical embodiments of the invention and are not therefore to be considered to limit the scope of the invention.

FIG. 1 is a perspective view of a self-adhesive pad in accordance with a representative embodiment of the present invention.

FIG. 2 is a detailed view showing a method of protecting and occluding the adhesive material of a self-adhesive pad in accordance with a representative embodiment of the present invention.

FIG. 3 is a detailed view showing an alternative method for deploying adhesive tabs in accordance with a representative embodiment of the present invention.

FIG. 4 is a detailed view of an adhesive area of a self-adhesive pad in accordance with a representative embodiment of the present invention.

FIG. 5, shown in parts A-D, demonstrate a system and method for providing an adhesive bond for the peripheral edges of a bench pad in accordance with a representative embodiment of the present invention.

### DETAILED DESCRIPTION OF THE INVENTION

Embodiments of the present invention will be best understood by reference to the drawings, wherein like reference numbers indicate identical or functionally similar elements. It will be readily understood that the components of the present invention, as generally described and illustrated in the figures herein, could be arranged and designed in a wide variety of different configurations. Thus, the following more detailed description, as represented in the figures, is not intended to limit the scope of the invention as claimed, but is merely representative of presently preferred embodiments of the invention.

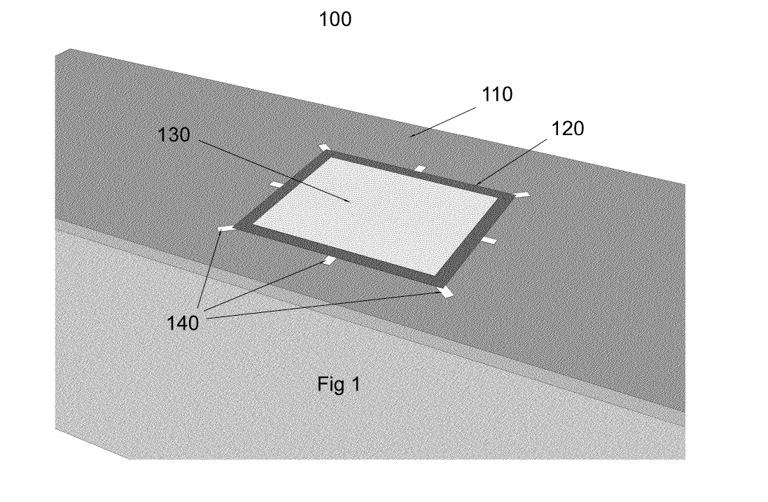

One embodiment of the invention is shown in FIG. 1. In this FIG. 100, a laboratory bench surface 110 is shown, to which a bench pad consisting of a moisture-proof barrier 120 underlies an absorbent material layer 130. The bench pad is affixed to the bench surface by a plurality of adhesive strips 140 that are pre-bonded to the underside of the moisture-proof barrier. The adhesive strips are supplied with an adhesive material bonded to the underside of the strip where it may contact and bond to the working surface. In some embodiments, the moisture-proof barrier 120 is folded over the absorbent material at the edge border to contain absorbed liquids that may otherwise pool and leak at the periphery of the pad. In some embodiments, the folded over peripheral margin may be 0.5 to 2 inches in width.

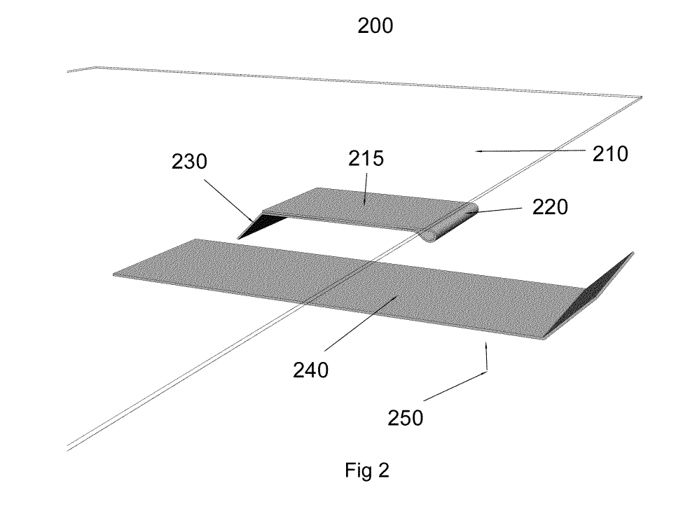

The adhesive strips are supplied in a manner that prevents exposure of the adhesive layer until the intended time of deployment. FIG. 2 shows a method of protecting and occluding the adhesive material until the time of use. The underside of the bench pad 200 moisture-proof barrier 210 is bonded to an adhesive strip 215, the underside of which is coated with an adhesive material. The adhesive material is prevented from bonding until the intended time of deployment by a folding of the strip back upon itself 220, thereby placing the adhesive region in contact with an area of the underside of the tab which is coated with a material that has a weak bonding strength for the adhesive. By grasping the deployment tab 230 between the thumb and forefinger, the strip may be pulled straight 240 thereby exposing the adhesive area 250 which now can be pressed against the working surface, thereby initiating the adhesive bonding of the strip to the surface. The tabs have an added benefit in that tension can be place upon the tabs prior to adhesion to the working surface to smooth and level the bench pad.

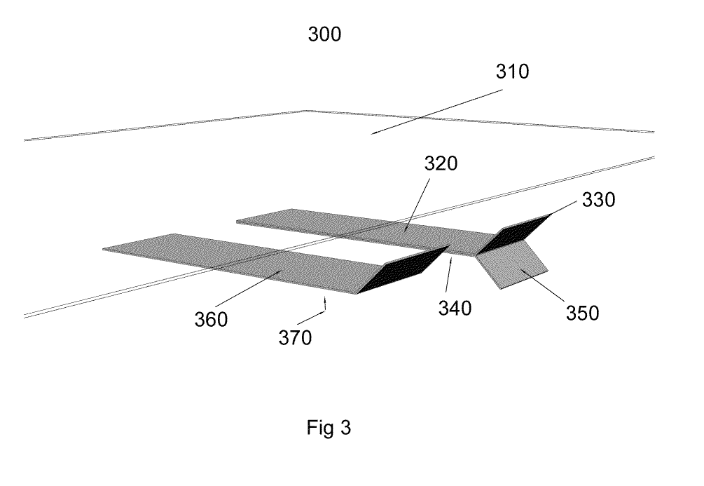

An alternative method of deployment of the adhesive tabs is shown in FIG. 3. In this embodiment, the moisture-proof barrier 310 of the bench pad 300 is bonded to a plastic strip 320, the underside of which is coated with an adhesive material except on the area of an attached finger tab 330. The adhesive is occluded by means of a second barrier strip 350 of plastic or paper-plastic laminate that has a weak bonding surface where it is in contact with the adhesive material and prevents unintentional contact of the adhesive until the barrier strip is removed by separating the two attached tabs 330 and 350, thereby peeling away the barrier strip. Once the barrier strip is removed, the tab 360 with the exposed adhesive undersurface 370 can then be pressed against the working surface for bonding. An example of this method for occlusion and deployment of an adhesive strip is commercially available in Band-Aid brand adhesive bandages by the Johnson and Johnson Company.

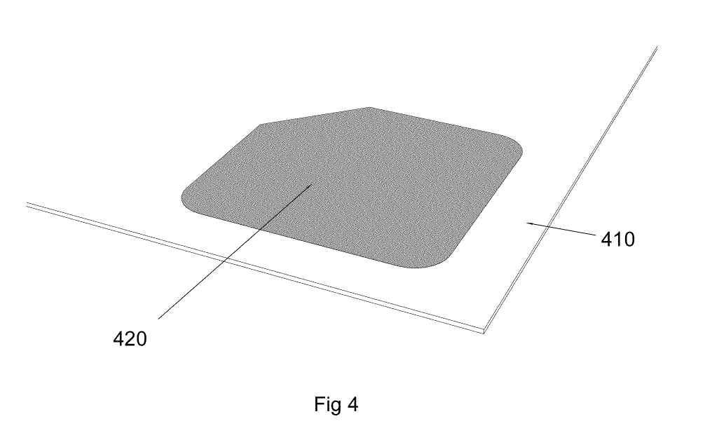

Another embodiment is shown in FIG. 4. In this embodiment 400, the adhesive area 420 is applied directly to the underside of the moisture-proof barrier 410. The adhesive barrier is occluded by a barrier strip in the manner shown in FIG. 3, until attachment, at which time the barrier strip is removed and the adhesive area is pressed against the working surface for bonding. This embodiment is useful when the application requires placement of the bench pad next to a vertical surface or where tab extensions or tape may interfere with operations of the working surface.

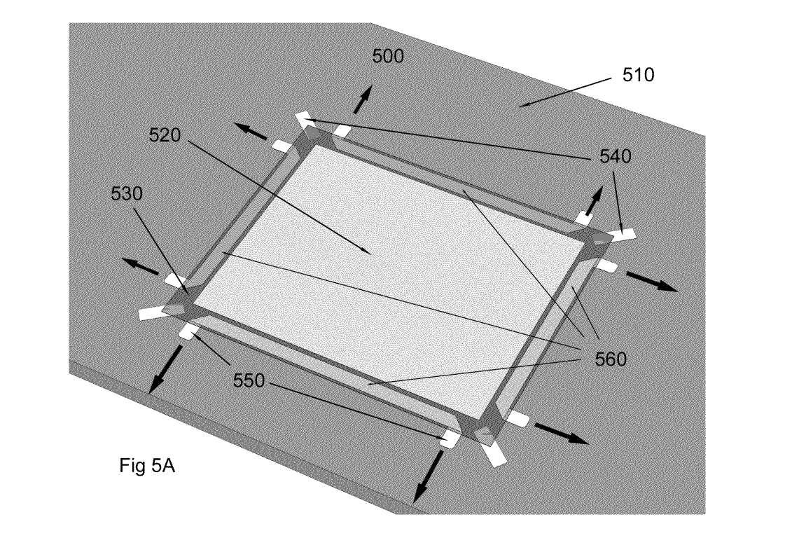

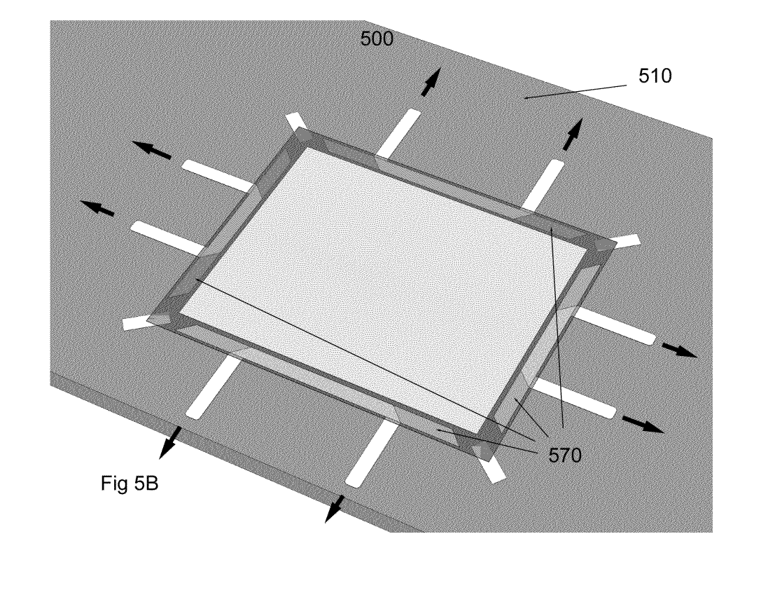

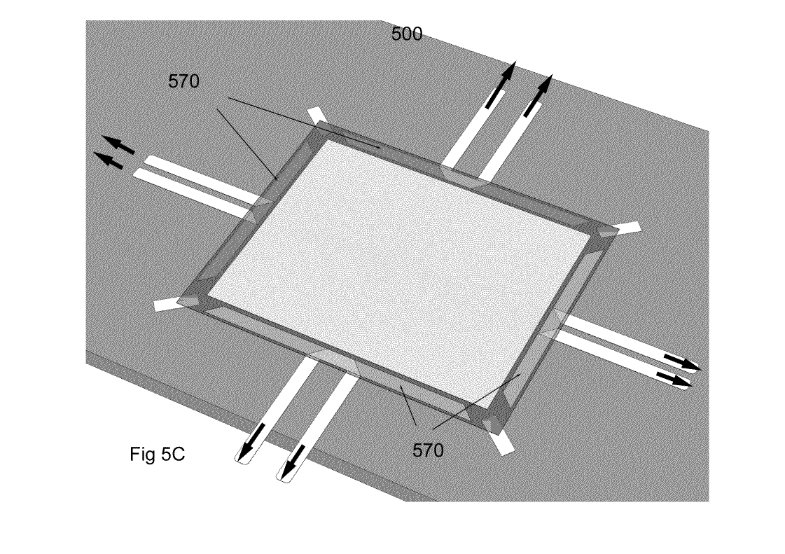

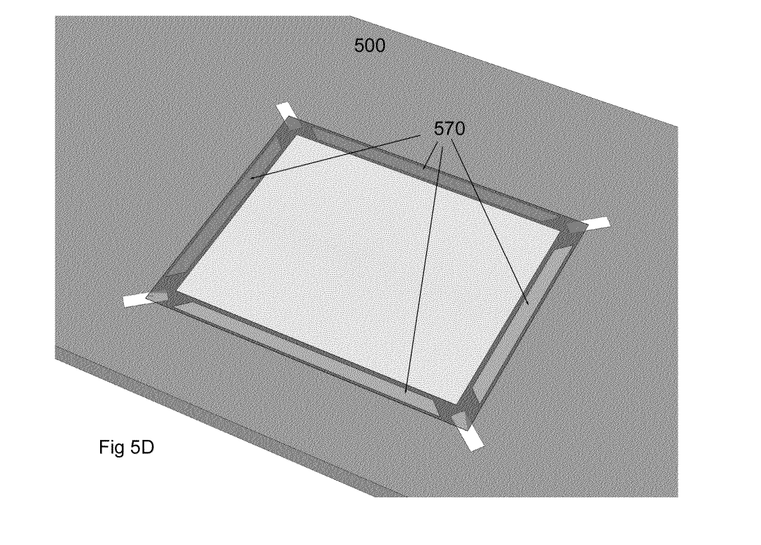

Some laboratory users prefer to bond their bench pads to the working surface and also tape the entire periphery of the bench pad so that the edges are not easily lifted or become snagged during the daily operations performed on the bench pad. Another embodiment of the invention is shown in FIGS. 5A through 5D that will provide an adhesive bonding for the peripheral edges of the bench pad. Referring to FIG. 5A, in this embodiment, regions of the underside of the bench pad moisture proof material 530 (shown in partial transparency) is coated with adhesive 560. The regions of adhesive are occluded by backing strip material with a low adhesion property for the selected adhesive. The backing material has tab extensions 550 that are folded laterally and protrude beyond the edges of the backing material 530. In this embodiment, the bench pad is positioned on the working surface 510, and anchored by deploying the four corner adhesive tab extensions 540. The bench pad edges are then adhered by pulling the backing tabs 550 away from the bench pad initiating a progressive removal of the backing material from the adhesive coating material as shown in FIG. 5B, thereby exposing the adhesive material 570 to the working surface 510. Continued tension on the tabs will further expose the adhesive as shown in FIG. 5C, until the backing material is completely removed (FIG. 5D). The adhesive bench pad can then be pressed against the working surface from above to securely bond the bench pad to the working surface.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

What is claimed is:

1) A device consisting of an absorbent material with a liquid-proof layer backing that has preconfigured, permanently bonded adhesive regions for the purpose of temporarily adhering the device to a work surface.

2) The device of claim 1, wherein the adhesive region consists of a tab extension bonded to the absorbent material or the waterproof backing material.

3) The device of claim 1, wherein the adhesive region is a peripheral sub-area of the underside of the liquid-proof material.

4) The device of claim 1, wherein the working surface is a laboratory bench top, laboratory isolation hood, incubator, refrigerator, a stationary or mobile working surface in a laboratory, clean-room, clinic, hospital, medical facility, ambulance, office or home.

5) The device of claims 1, wherein the affixed adhesive strips are pre-configured with the adhesive region folded back upon a weakly adhesive or non-adhesive region, until the intended time of use, at which time the adhesive region is unfolded or unblocked and bonded with the surface target.

6) The device of claims 1, wherein the affixed adhesive strips are occluded from contact by a non-adhesive backing that is intended to be completely removed at the time of intended use to allow bonding of the adhesive with the surface target.

7) The device of claims 1, wherein the adhesive strips and regions, following bonding to the working surface can be removed or peeled from the surface using moderate hand force.

8) The device of claims 1, wherein the adhesive material has sufficient tensile strength to withstand normal and incidental forces on the affixed pad without separating from the pad.

9) The device of claims 1, wherein the adhesive does not leave a residue on the bonded surface upon removal.

10) The device of claims 1, wherein the bench pad is used as a disposable item.

11) The device of claims 1, wherein the bench pad is provided as sterile in sealed packets.

12) The device of claims 1, wherein an adhesive region is supplied on the underside of all edge areas of the bench pad to bond all edges of the bench pad to the working surface.

13) The device of claims 1, wherein the adhesive material is occluded by weakly adhesive material until deployed on the working surface as described in FIGS. 5A through 5D.

14) The device of claims 1, wherein the device is supplied as an individual separate bench pad.

15) The device of claims 1, wherein the devices are supplied in a roll format as concatenated pads with perforated junctions to facilitate individual pad separation.

16) The device of claims 1, wherein the device is supplied as a continuous roll with a repeated pattern of adhesive regions by which cut segments of the roll material may be affixed to a working surface.
